(19) United States
(12) Patent Application Publication
(10) Pub. No.: US 2009/0241784 A1
(43) Pub. Date: Oct. 1, 2009

(54) Marshmallow toasting apparatus and method

(76) Inventor: D. Scot Colby, Elk Grove village, IL (US)

Correspondence Address: Meroni & Meroni, P.C., P.O. Box 309, Barrington, IL, 60011, US

(21) Appl. No.: 12/079,787

(22) Filed: Mar. 28, 2008

(51) Int. Cl. A47J 37/04; A23G 3/02; A47J 37/00; A23L 1/01

(52) U.S. Cl. 99/421 A; 426/523; 426/233; 99/427; 99/441; 99/426

(57) ABSTRACT

A marshmallow toasting apparatus and method caramelizes the outer skin of marshmallow and is designed for countertop use. The apparatus comprises a housing, a spit or skewer, and a heat source. The housing includes top and front walls having a common slot extending therebetween. The common slot defines a marshmallow-receiving cavity and a spit-receiving plane. The spit or skewer may be rotated by way of a rotisserie assembly, as an optional feature. The spit is receivable in the spit-receiving plane and is rotatable therein substantially parallel to the top wall. The heat source is positioned adjacent the cavity for caramelizing the outer skin of marshmallow via directed heat energy. The cavity is sized and shaped for enabling structurally free thermal expansion of marshmallow during application of heat to the cavity.

### BACKGROUND OF THE INVENTION

1. Field of the Invention

The present invention generally relates to an apparatus for toasting marshmallows, and more particularly, to a marshmallow toasting apparatus and method whereby marshmallows are skewered, and placed into a marshmallow-receiving cavity, surrounding which cavity is a heat source for providing radiant heat energy to toast or caramelize the outer skin of the marshmallow.

2. Description of the Prior Art

Sources indicate that as early as 2000 BC, Egyptian people were the first to enjoy a confection now referred to as marshmallow. This ancient marshmallow treat was made from the mallow plant (Athaea officinalis) that grows wild in marshes. The Egyptians squeezed sap from the mallow plant and mixed it with nuts and honey. The French were introduced to marshmallow in the early to mid-1800's. Owners of small candy stores typically hand whipped sap from the mallow root and directed the same into a candy mold. In the late 1800's, candy makers started molding marshmallow via a modified cornstarch medium. At about this same time, candy makers replaced the mallow root with gelatin, which created a stable form of marshmallow.

Marshmallows were introduced and popularized in the United States in the early 1900's, after the new manufacturing process was developed. In the mid-1900's, Alexander J. Doumak revolutionized the process for manufacturing marshmallows by developing and patenting an extrusion process, whereby combined marshmallow ingredients were extruded, cut into pieces, and packaged. (See, for example U.S. Pat. No. 2,847,311). In the 1950s, Jet-Puffed marshmallows by Kraft (currently doing business as Kraft Foods Inc. with corporate headquarters at Three Lakes Drive, Northfield, Ill., 60093) became extremely popular in the United States. Kraft employed a new technique, in which all ingredients were whipped together during the heating process. The marshmallow mass was then cooled slightly before being extruded. This, and the fact that the ingredients used are relatively cheap, allowed Kraft to make vast quantities of marshmallows inexpensively.

A popular camping or backyard tradition is the toasting or roasting of marshmallows over a campfire or other source of an open flame. A marshmallow is typically placed on the end of a skewer type implement and held over the flame until it turns golden brown. This creates a caramelized outer skin with a somewhat liquefied layer deep to the outer skin. According to individual preference, the marshmallows are heated to various degrees—from a gentle toasting to burning the outer layer. Either the toasted marshmallow can be eaten whole or the outside layer may be consumed separately and the marshmallow toasted again.

A fair degree of development in the field of marshmallow toasting devices and the like has occurred. Some of the more pertinent prior art relating to marshmallow toasting devices and similar other means and methods for toasting and/or roasting food are briefly set forth hereinafter. For example, U.S. Pat. No. 2,183,938 ('938 Patent), which issued to Lewis, discloses a Marshmallow Toaster. The '938 Patent describes a culinary utensil essentially comprising a plate member; a series of pairs of arms projecting radially outward from the plate member, which arms are bent at right angles to form pairs at times; a handle; and means for detachably attaching the handle to the plate member.

U.S. Pat. No. 2,205,914 ('914 Patent), which issued to Stafford, discloses a Barbecuing Apparatus. The '914 Patent describes an apparatus for barbequing articles of food, comprising a housing defining a chamber open at one end, a cover pivoted to the housing for closing the chamber, heater means within the chamber for supplying a roasting or barbequing heat, means for supporting the articles of food within the chamber and for turning the same around the heater means and about their own axes, receptacle means disposed in the chamber and suspended from the cover for holding flavoring means, the receptacle being removable from the chamber by the act of opening the cover, and igniter means for burning the flavoring means to create a relatively dense fog or smoke for flavoring the articles of food as same are subject to the roasting or barbequing heat from the heater means.

U.S. Pat. No. 2,232,400 ('400 Patent), which issue to Martin, discloses a Marshmallow Toaster. The '400 Patent describes a device of the character described as a pocket for supporting an article at spaced points to expose a maximum amount of the article surface, a support for the pocket mounted for movement to place the pocket in article treating and discharging positions, and a heating element adjacent the pocket in the article treating position thereof for applying heat on article supported in the pocket.

U.S. Pat. No. 2,484,858 ('858 Patent), which issued to Schmidt, discloses a Marshmallow Roaster. The '858 Patent teaches a device for roasting marshmallows or the like comprising a pair of rods integral at one end to form a handle, clamps for holding the rods together, an oven, the lower ends of the rods being secured to the oven, a sleeve slidably positioned on the rods, a pair of prongs for holding marshmallows secured to the sleeve, and a handle on one of the prongs for moving the prongs and marshmallows into the oven preparatory to placing the oven in a fire for the roasting of the marshmallows.

U.S. Pat. No. 2,487,651 ('651 Patent), which issued to Gudmundsen, discloses a Marshmallow and Wiener Toaster. The '651 Patent essentially teaches a toaster comprising a handle and a basket-like enclosure on the handle of a shape and size for holding a marshmallow as it is toasted and wherein the marshmallow may be tumbled about by manipulation of the handle so that the marshmallow will be evenly toasted on all sides and will not stick to the enclosure.

U.S. Pat. No. 3,125,015 ('015 Patent), which issued to Schlaegel, discloses a Rotisserie Wheel. The '015 Patent describes a rotisserie wheel comprising a support member adapted for rotation in a vertical plane, a plurality of spits rofatably secured to the support member so that their major lengths extend therefrom in the same direction on a horizontal plane and in a concentric spaced relationship relative to the support member, a gear wheel carried by each respective spit, each of the gear wheels in mesh with at least one of the other the wheels, a bearing member in axial alignment with and secured to the support member for rotation therewith, a spur gear carried by the bearing member, the bearing member susceptible of rotation independently of the spur gear, the support member adapted for mounting on a motor driven shaft for rotation therewith, a second gear wheel rotatably mounted to the support member in mesh with the spur gear and at least one of the first mentioned gear wheels, a pendulum secured at one end to the spur gear so as to depend therefrom, a weight means on the free end of the pendulum, and the pendulum being maintained in a depending relationship to the spur gear by gravity during rotation of the support member to thereby hold the spur gear against rotation.

U.S. Pat. No. 3,744,403 ('403 Patent), which issued to Castronuovo, discloses a Marshmallow Toasting Device. The '403 Patent teaches an electrical appliance for toasting marshmallows comprising a housing having a base in which an electric motor driven by house current drives a gear train so to rotate a horizontal turntable that travels under a canopy that serves as an oven where electric heating elements are located, and the turntable supporting upright picks on each of which a marshmallow is impaled, each pick slowly rotating as the turntable turns, so that all sides of the marshmallow are faced to the oven heating elements during toe toasting operation.

U.S. Pat. No. 5,172,628 ('628 Patent), which issued to Pillsbury et al, discloses a Rotary Food Cooking Device for a Grill. The '628 Patent teaches an apparatus for cooking food atop a barbeque grill or the like including a hollow rectangular frame having front and rear walls coupled by adjustable side walls to adapt the unit to different size barbeque grills. A plurality of food receiving skewer blades are rotatably mounted on the front and rear walls and include a pointed end for piercing food and a handle end which can be gripped for removing the skewer blades. One of the skewer blades is rotatably driven via a motor mounted thereon adjacent the front wall. The rotation of the driven skewer blade is coupled to the remaining skewer blades via intermeshing gears rotatably mounted on the rear wall.

U.S. Pat. No. 6,009,796 ('796 Patent), which issued to Larzik, discloses a Marshmallow Toasting Apparatus. The '796 Patent describes a marshmallow toasting stick, particularly suited for camp fire use, including a substantially round wooden stick of a certain stick length and a certain cross-sectional stick diameter; a substantially round handle at a first end of the stick of a smaller handle length and a larger handle cross-sectional diameter. A taper is formed at a second end of the stick to a blunt point of still smaller cross-sectional diameter, with the handle color-coded for identifying the user of the stick, and with the stick and handle dimensions being selected so that one or more marshmallows could be suspended over the flames of a camp fire from a distance which protects an adult or child user from the heat of the fire.

U.S. Pat. No. 6,877,232 ('232 Patent), which issued to Harmon et al., discloses a Marshmallow Toasting Utensil and Method. The '232 Patent describes a marshmallow-toasting utensil comprising a handle and a wire assembly with at least one wire segment extending from the handle. In some embodiments, the wire assembly includes deflectable wire segments with end regions that are biased to a spread-apart configuration. During use, the end regions are urged together and a marshmallow is impaled upon the ends. As the inside of the marshmallow melts, the end regions return toward the unbiased configuration. In some embodiments, the utensil is a collapsible utensil where the wire assembly is selectively positionable between at least extended and collapsed configurations. In some embodiments, the wire segments are adapted to pivot between the stowed and extended configurations. In some embodiments, the wire segments are selectively removable from the handle. In some embodiments, the wire segments are selectively extendable from and/or stored within the handle.

It may be seen from an inspection of the foregoing art, as well as from a consideration of the state of the art generally, that the prior art does not disclose a marshmallow toaster or marshmallow toasting apparatus sized and shaped for countertop use, and incorporating a marshmallow receiving cavity allowing for unhindered marshmallow expansion during the toasting process. The prior art thus perceives a need for such an apparatus and associated methodology as set forth in more detail hereinafter.

### SUMMARY OF THE INVENTION

Accordingly, it is an object of the present invention to provide a small home appliance for toasting marshmallows. The toasting apparatus is specifically designed to be able to toast one or more standard size marshmallows, on a skewer or spit, in one or more slots or marshmallow-receiving cavities. Conceivably, the toasting apparatus could be adapted for receiving various and non-standard size and shaped marshmallows.

The skewer or spit member is on the order of ten (10) inches in length, and one-eighth (⅛) of an inch in diameter or transverse width. The spit-receiving slot is greater than the width of the spit, but minimized so that thermal energy from the marshmallow-receiving cavity may be maximally structurally retained at the front and rear walls. The skewer and marshmallows may thus be placed into the slot.

Once in the slot, it is contemplated that appliance may be activated by either manually closing a switch or button, or by closing a switch by the action of placing a skewer into the slot. The amount of time spent in the appliance may be preferably set on a control panel for the desired amount of browning. A rotisseries type mechanism is further contemplated for rotating the skewer and marshmallow(s).

In practice, cavity temperatures may exceed 200° Celsius, and it has been found that the diameter of a standard marshmallow may expand by as much as 30-50 percent. For this reason, the marshmallow-receiving cavity is sized and shaped to accommodate marshmallow expansion according to the foregoing specifications, and bearing in mind that a standard marshmallow, as may be exemplified by a Jet-Puffed brand marshmallow, is typically cylindrical and on the order of one (1) inch in height and one (1) inch in diameter.

It is further noted that heating a marshmallow in a low heat environment often causes the marshmallow to warm uniformly from the outside to the inside, which softens or liquefies the inner portions of the marshmallow, and causes the marshmallow to release from the skewer. The placement of a marshmallow on a skewer, and optionally rotating the same within a cavity surrounded by high resistance heating elements, provides a uniformly caramelized or seared outer skin of the marshmallow while retaining a substantially solid foam-like center for frictionally retaining the marshmallow upon the skewer.

Although heating elements are here mentioned as being one source of (radiant) heat, it is further contemplated that an open flame, as enabled via a gas delivery assembly, may further provide the required means for caramelizing the outer marshmallow skin. Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of patent drawings:

FIG. 1 is a top perspective view of a first embodiment of the marshmallow toasting apparatus according to the present invention showing a single skewer member with a single marshmallow skewered thereby and received in a marshmallow/skewer-receiving slot and being manually rotated about an axis of rotation such that the marshmallow is centrally positioned relative to peripheral heating elements.

FIG. 2 is a top perspective view of the first embodiment of the marshmallow toasting apparatus according to the present invention showing a single skewer member with two axially aligned and spaced marshmallows skewered thereby and received in the marshmallow/skewer-receiving slot and being manually rotated about an axis of rotation such that the marshmallows are centrally positioned relative to peripheral heating elements.

FIG. 3 is a top perspective view of a second embodiment of the marshmallow toasting apparatus according to the present invention showing dual skewer members, each with two axially aligned and spaced skewered marshmallows and received in dual marshmallow/skewer-receiving slots, one of which is being manually rotated about an axis of rotation such that the marshmallows are centrally positioned relative to peripheral heating elements.

FIG. 4 is a top perspective view of a third embodiment of the marshmallow toasting apparatus according to the present invention showing a single skewer member with a single marshmallow skewered thereby and received in a marshmallow/skewer-receiving slot and being manually rotated about an axis of rotation such that the marshmallow is positioned above open flames.

FIG. 5(a) is a diagrammatic perspective type depiction of upper and lower skewered, cube-like marshmallows, the upper of which is in a room temperature environment, and the lower of which is in a relatively more heated environment.

FIG. 5(b) is a diagrammatic perspective type depiction of upper and lower skewered, cylindrical marshmallows, the upper of which is in a room temperature environment, and the lower of which is in a relatively more heated environment.

FIG. 6 is a top view of the marshmallow toasting apparatus otherwise depicted in FIG. 2 symbolically showing laterally opposed, and otherwise hidden heating elements imparting heat energy into a marshmallow-receiving cavity or chamber thereby operating to thermally expand room temperature marshmallows (in solid lines) to a thermally expanded state (in broken lines).

FIG. 7 is a lateral view of the marshmallow toasting apparatus otherwise depicted in FIG. 2 with certain parts broken away to symbolically show upper and lower heating elements imparting heat energy into the marshmallow-receiving cavity or chamber with fragmentary, phantom skewered marshmallows being rotated about a pivot point in a skewer receiving plane into the skewer-receiving slot.

FIG. 7(a) is a fragmentary lateral view of a marshmallow toasting housing with a rotisserie assembly positioned adjacent one end thereof, the rotisserie assembly being rotatable intermediate a marshmallow loading position (shown in solid lines) to a marshmallow toasting position (shown in broken lines).

FIG. 7(b) is a diagrammatic cross-sectional depiction through the marshmallow receiving slot of FIG. 7 depicting the skewer member operating to depress an insulative member for closing a heating element operative switch.

FIG. 8 is a lateral view of the marshmallow toasting apparatus otherwise depicted in FIG. 4 with certain parts broken away to more clearly show three cavity or chamber-received marshmallows above open flames as enabled by a gas delivery assembly.

FIG. 9 is an end view through a skewer member showing a marshmallow skewered thereby and positioned in front of an end wall, which marshmallow is in a first rotational position and which end wall is outfitted with a heat reflective material.

FIG. 10 is an end view through a skewer member showing a marshmallow skewered thereby and positioned in front of an end wall, which marshmallow is in a second rotational position and which end wall is outfitted with a heat reflective material.

FIG. 11 is a fragmentary laterally sectional depiction showing left and right end walls or front and back walls and a bottom wall with a symbolic representation of a heating element extending intermediate the end walls imparting heat energy into the marshmallow-receiving cavity or chamber and heat energy being reflected from the walls as outfitted with a heat reflective material.

FIG. 12 is a top perspective view of a fourth embodiment of the marshmallow toasting apparatus according to the present invention with two axially aligned and spaced marshmallows skewered thereby and supported in an elevated position relative to a heated chamber by way of skewer longitudinally opposed skewer-elevating tabs.

### DETAILED DESCRIPTION OF THE PREFERRED EMBODIMENT(S)

The modem marshmallow confection typically comprises cane sugar or corn syrup, water, pre-softened gelatin, dextrose, and flavorings. The ingredients are whipped to a spongy consistency during a warming process. After slightly cooling the whipped ingredients, the same are extruded, and typically cut into cylindrical sections, which, as preferred for marshmallow toasting scenarios, are typically on the order of one (1) inch in length or height and one (1) inch in diameter at room temperature.

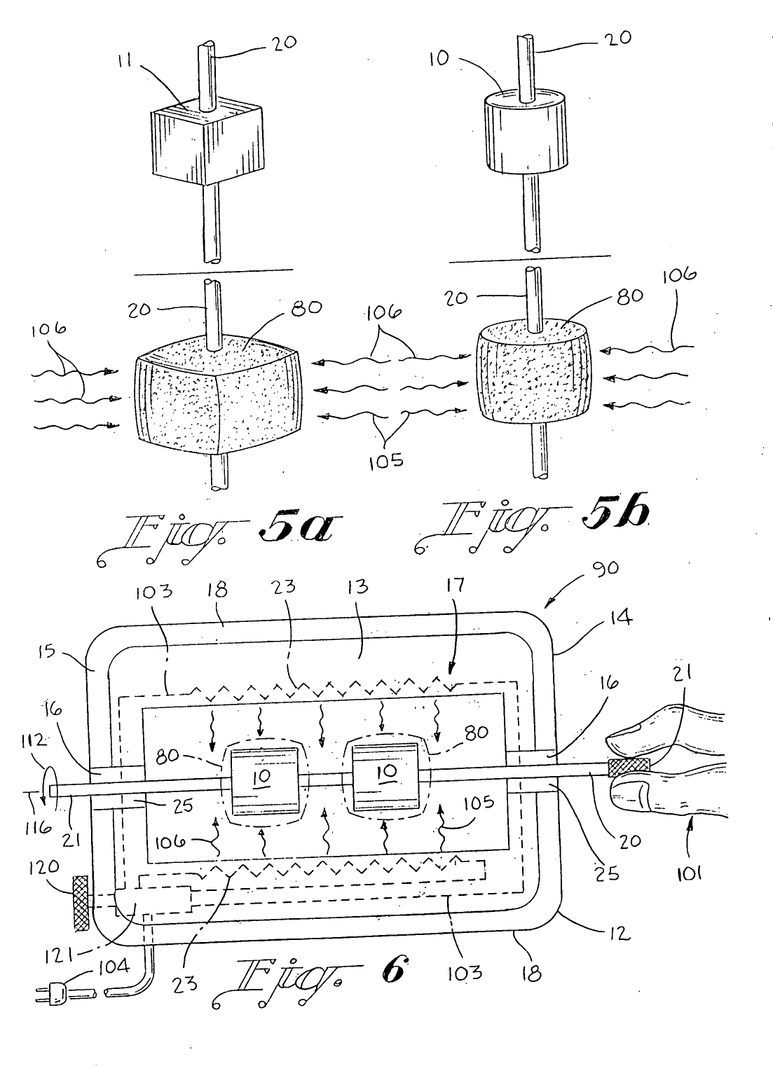

A cylindrical marshmallow 10 at room temperature is generally depicted and referenced in FIG. 5b. Marshmallows of the type generally depicted in the noted figure are arguably the most common. It should be noted, however, that marshmallows can generally be formed in just about any conceivable shape or size. A generic cube-like marshmallow 11 at room temperature has been depicted and referenced in FIG. 5a to show that marshmallows need not adhere to the cylindrical shape and size generally shown in FIG. 5b.

Given, however, that typical marshmallows such as those sold under the brand name JET-PUFFED by Kraft Foods Inc., is generally cylindrically shaped and something on the order of one (1) inch in height by one (1) inch in diameter at room temperature, it is contemplated that the volume of such a marshmallow is on the order of 0.785 cubic inches or roughly 1.29×10⁻² liters per the volumetric equation for a cylinder:

V=πr²h,

where “V” is the volume; “π” is a constant (i.e. the ratio of any circle's circumference to its diameter) of about 3.14; “r” is the radius of the cylinder, and “h” is the height of the cylinder. Given a cubic marshmallow (as at 11) with each side being roughly one (1) inch, the volume of such a cubic marshmallow would be one (1) cubic inch, or roughly 1.64×10⁻² liters, which yields a handy conversion factor.

It will be recalled from above that the ingredients of mass manufactured marshmallows are currently whipped during a warming process. Marshmallows are thus a mixture of not only sugar, and gelatin, but air. Marshmallows may thus be characterized as closed-cell, foam-like bodies, and mostly air by volume. Experiments have shown that when placed in a vacuum pump, they expand as the pressure decreases.

Break the seal on the vacuum container and they shrink during the return to normal atmospheric pressure. Since the vacuum pump pulls on the marshmallows hard enough to burst some of the air bubbles, they are actually a bit smaller and more shriveled at the end of this experiment. This illustrates a fundamental, yet important, property of gases. The pressure of a gas is inversely proportional to its volume during an isothermal process or when temperature is constant. Symbolically, this may be reduced to:

PᵢVᵢ=P_{f}V_{f}=constant,

where PᵢVᵢ is the product of the initial pressure and volume, and P_{f}V_{f} are the product of the final pressure and volume. This relation, of course, stems from the Ideal Gas Law:

PV=nRT

where “P” is the absolute pressure; “V” is the volume of the vessel; “n” is the number of moles of the gas present; “R” is the universal gas constant; and “T” is the absolute temperature.

During a marshmallow toasting operation, it may be assumed that the process is generally isobaric or at constant pressure, and in this case, the volume of a gas (such as the air bound by the frozen foam) is directly proportional to its temperature. Symbolically, this may be reduced to:

V_{f}Tᵢ=VᵢT_{f}, or

V_{f}=Vᵢ·(T_{f}÷Tᵢ)

where V_{f}T_{i is} the product of the final volume and the initial temperature, and VᵢT_{f} is the product of the initial volume and the final temperature. It should be noted that if the initial and final temperatures are fairly uniform, as they might during the process of marshmallow toasting, the term: (T_{f}÷Tᵢ) is a fairly constant ratio, and may be utilized in combination with the initial volume to predict the final volume. In other words, if the initial and final temperature may be known, as well as the initial volume, then the final volume may be roughly and easily predicted.

Assuming that the initial volume of a marshmallow at room temperature (about 20° Celcius) is roughly 0.785 in or 1.29×10⁻² L, and that a modest temperature for roasting a marshmallow is about 200° Celcius, then the final volume of a toasted marshmallow may be something on the order of 1.26 in³ or roughly 2.1×10⁻² L. Assuming further substantially equal directional expansion, and that the expansion coefficients of the materials constituting the cells are negligible relative to the-expansion coefficient of air, the final height and diameter might be something on the order of 1.17 inches or roughly between 15 and 20 percent directional expansion.

In practice, marshmallow toasting temperatures often exceed 200° Celcius, and it has been found that the diameter of a standard marshmallow may expand by as much as 30-50 percent. For this reason, the marshmallow toasting apparatus 90 according to the present invention comprises a marshmallow-receiving cavity or chamber 17 sized and shaped to accommodate marshmallow expansion according to the foregoing specifications, noting that the most common marshmallow at room temperature is typically cylindrical and on the order of one (1) inch in height and one (1) inch in diameter as at marshmallow 10.

Over the open flame of a campfire, marshmallow expansion is typically not problematic. However, if a countertop device is to be provided for toasting marshmallows, the device must conform to certain specifications, and should be sized and shaped so as to accommodate or receive the typical marshmallow (as may be exemplified by the cylindrical JET-PUFFED brand marshmallow having a one (1) inch diameter and one (1) inch height) and safely allow for normal expansion thereof under toasting (and other predictable) conditions.

Accordingly, the marshmallow toasting apparatuses 90, 91, and 92 according to the present invention each preferably comprise a housing 12 including a top wall 13, a front wall 14, and a back wall 15. One or more common slot(s) 16 extend through the planes of the top, front, and back walls 13, 14, and 15. The common slot(s) 16 essentially provide a pathway for receiving one or spits or skewer member(s) 20 and one or more marshmallow(s) 10 as skewered by the skewer member(s) 20.

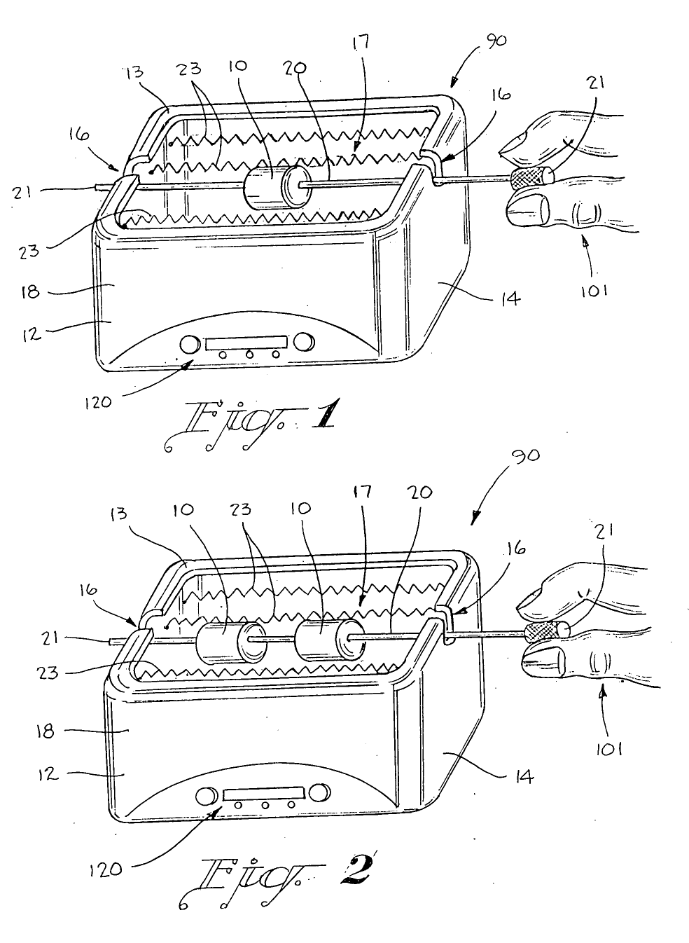

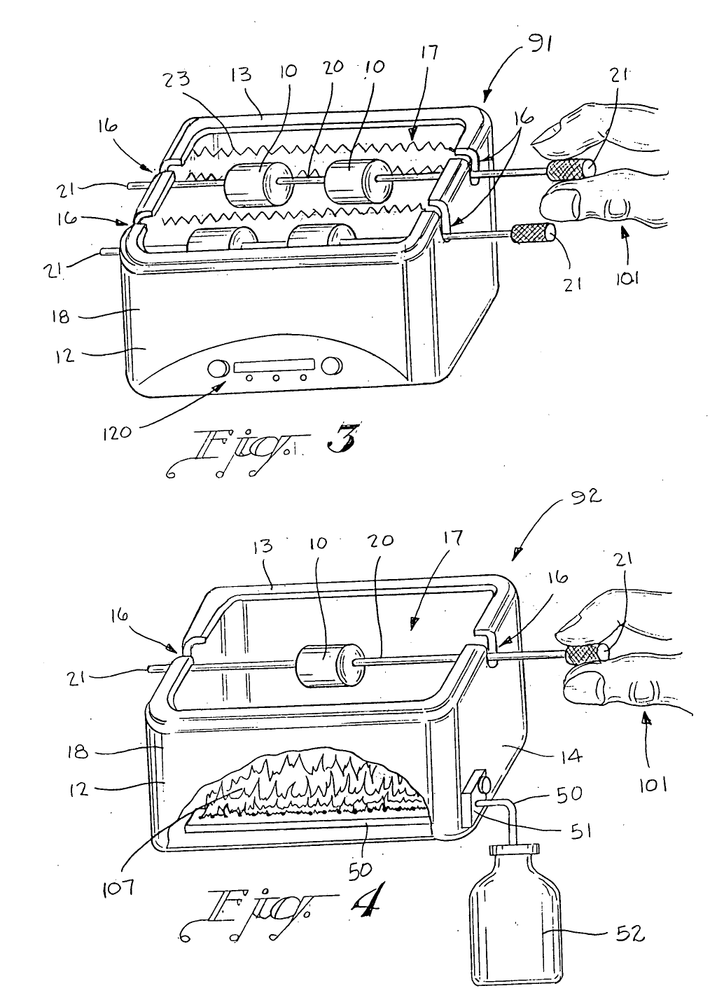

In other words, it may be seen from an inspection of FIG. 1 that a single common slot 16 extends intermediate the top wall 13 and front wall 14 and a single skewer member 20 is received therein. By contrast, FIG. 3 depicts dual, laterally-opposed common slots 16 and dual skewer members 20 received therein. It is contemplated that each marshmallow-receiving cavity or chamber 17 is sized and shaped to minimally accommodate the width of a thermally expanded marshmallow (as at 80), and to accommodate at least one but possibly a plurality of thermally expanded marshmallow lengths as axially aligned, spaced, or otherwise skewered by a skewer member 20.

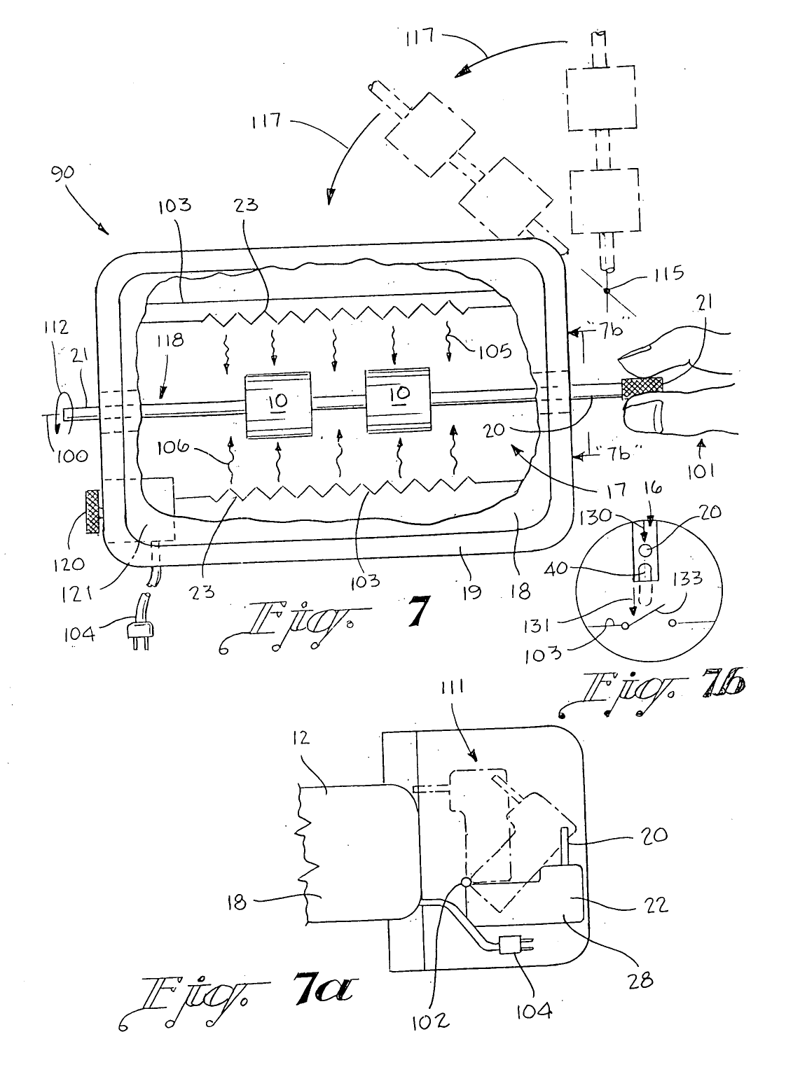

Each spit or skewer member 20 is preferably rotatable about a point (as at 115 in FIG. 7) in a spit-receiving plane 116 extending in or parallel to the common slot(s) 16 as referenced in FIG. 6. One or more marshmallows 10 may be skewered by each skewer member 20 and positioned intermediate the ends 21 of the skewer member(s) 20. The skewer members 20, when so outfitted with one or more marshmallows 10, may be rotated (as at 117) or otherwise positioned into a substantially horizontal orientation (as at 118) for positioning the marshmallow(s) 10 within a marshmallow-receiving cavity or chamber 17 defined, in part, by the common slot 16.

The marshmallow-receiving cavity or chamber 17 is preferably sized and shaped to safely accommodate one or more expanded marshmallow(s) as at 80. In this last regard, it is contemplated that the cavity or chamber 17 may comprise a cavity width greater in magnitude than the width of the common slot 16 at the front and back walls 14 and 15. The slot widths at the front and back walls 14 and 15 are designed for receiving the skewer member(s) 20 and the cavity or chamber 17 is designed for receiving room temperature marshmallows 10, and allowing thermal expansion thereof to the expanded marshmallow state as at 80.

Given that a toasted or thermally expanded marshmallow 80 may be on the order of 1.5 inches in diameter, it is contemplated that the preferred dimensions of the cavity or chamber 17 be on the order of 2 to 2.25 inches in width, and 3 to 4 inches in depth. The length of the cavity or chamber 17 ultimately depends on the number of axially aligned and spaced marshmallows 10 to be toasted during any given operation. If two marshmallows 10 are to be toasted, for example, it is contemplated that the cavity length may preferably be on the order of at least 4 to 4.5 inches.

The front and back walls 14 and 15 may further provide certain means or cavity-defining structure adjacent the slot 16 for reflecting heat 106 toward received marshmallow(s) 10 for enhancing heat uniformity within the cavity 17. For example, walls of the cavity 17, as defined by interior portions of the front and back walls 14 and 15, may comprise energy reflective material or structure 70, such as may be exemplified by polished metallic material or mirror-like structure for reflecting heat energy (as at 106) into the cavity or chamber 17, as generally depicted in FIGS. 9-11.

Further, the width of the slots 16 may be minimized for receiving the skewer width, which minimized slot width functions to maximize the inner surface area of the front and back walls 14 and 15 adjacent the slots 16. It is contemplated that the maximized surface area adjacent the slots 16 at the front and back walls 14 and 15 may well function to reflect heat energy 106 into the cavity for enhancing uniformity of heat within the cavity 17.

Further the slots 16 may preferable terminate inferiorly or downwardly such that the common slots 16 provide certain means or structure for rotatably supporting the skewer members 20 during rotation about their axes as at 100 in FIG. 7. In other words, the user may rest the spit or skewer member 20 atop skewer supports 25 during skewer member 20 rotation, which supports 25 define the downward termini of common slots 16.

The skewer member 20 may be rotated about its axis 100 either manually as at 101 in FIGS. 1-4, 6, 7, and 8 or via a rotisserie assembly 22 as generically depicted in FIG. 7(a). In the latter case, it is contemplated that the rotisserie assembly 22 may be rotatable about a pivot point 102 for enabling the user to skewer marshmallow(s) 10 via the skewer member 20 when in a vertical orientation as shown in solid lines, and then pivot the rotisserie assembly 22 (or skewer member 20) about pivot point 102 for positioning the skewered marshmallow(s) 10 within the marshmallow-receiving cavity or chamber 17.

The housing 12 further preferably comprises side walls 18 and a bottom portion 19. It is contemplated that certain heat source-based means for caramelizing the outer skin of the marshmallow(s) 10 or 80 may be positioned within or adjacent the side walls 18 and/or bottom portion 19. Said means may well function to toast or caramelize a marshmallow 10 as received within the cavity or chamber 17 via a skewer member 20. It is contemplated, for example, that standard toaster type heating elements (as symbolically depicted at 23) made of Nichrome wire may be connected in circuit 103 with a power source (as exemplified symbolically by a power cord 104), and may provide an example of the means for caramelizing/toasting the outer skin of marshmallow(s) 10.

When the circuit 103 is closed, the heating elements 23 resist current and heat 106 builds up and migrates from the elements 23. Radiant heat as at 105 is also thereby directed from the elements 23 to the marshmallow(s) 10, and caramelization/toasting of the outer skin of the marshmallow(s) may commence. It is contemplated that certain means for timing the heat source may be included in the operating circuitry 103 for opening and closing a circuit switch according to preset time periods.

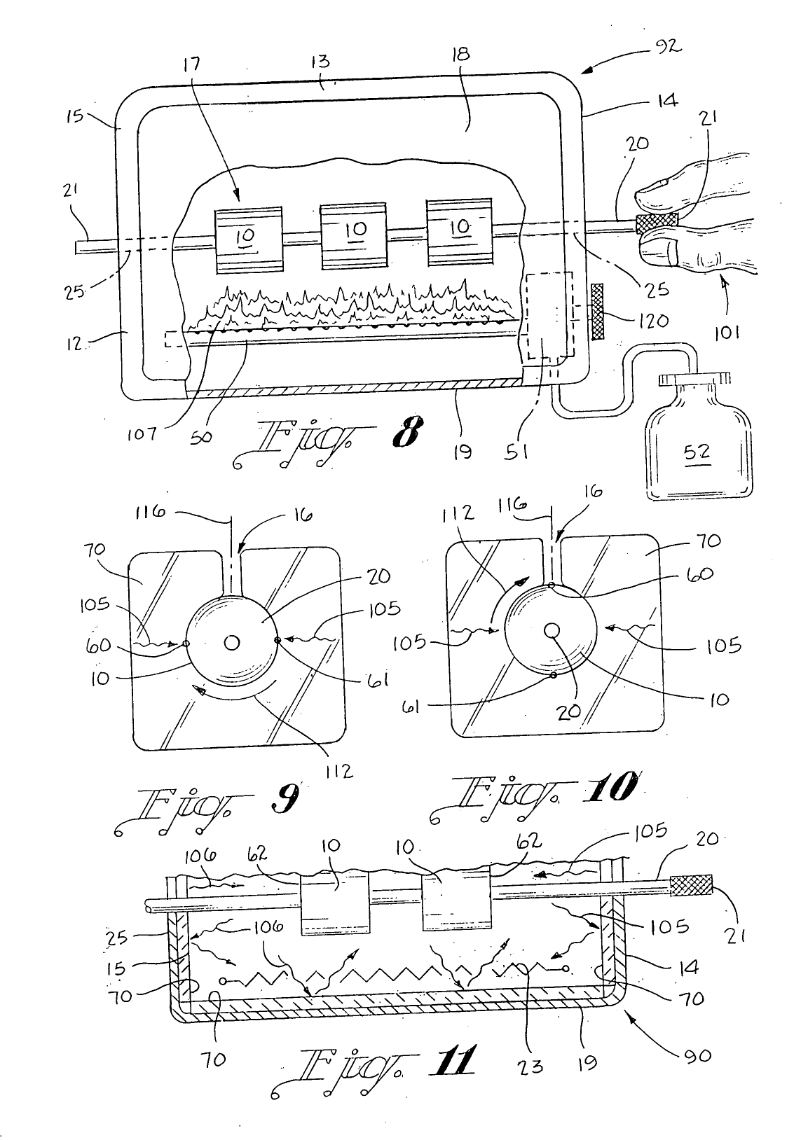

A thermostatic switch or similar other timing device, for example, could be incorporated into the circuitry 103 for enabling the user to selectively time heating periods. Certain external controls 120 are depicted in FIG. 1-3, 6, 7, and 8, and a black box 121 is depicted in FIG. 6 and 8. It is contemplated that the controls 120 and box 21 may control and/or house various means for effecting timed heating via state of the art means and methods.

It is further contemplated that during the step of slot-receiving a spit-skewered marshmallow 10, the operation itself may close a heat rendering circuit 103. In this regard, the reader is directed to FIG. 7(b). FIG. 7(b) diagrammatically depicts an insulative type button 40, which button 40 is movable intermediate an up position and a down position. It is contemplated that the up position may be a relaxed position, and if outfitted with certain spring means (not specifically shown), the down position may represent an actuated position.

The skewer and marshmallow load (as at 130) may be of sufficient magnitude to retain the button in the down, actuated position. When in the down position, as directionally shown at arrow 131, the button or similar other structure may operate to close a switch 133, thereby enabling current to flow through the heating elements 23, and render heat 106 to the cavity or chamber 17.

It should perhaps be noted here that a caramelized or toasted marshmallow results from the oxidation of sugar(s) in the marshmallow, whereas the toasting of bread stems from what is known as the Maillard reaction. The Maillard reaction is also a type of non-enzymatic browning, but involves reactions with amino acids. Caramelization of the outer skin of a marshmallow generally results from pyrolysis or the chemical decomposition of organic materials by heating in the absence of oxygen or other reagents.

The rotation of marshmallow(s) 10 as skewered on a rotatable skewer member 20 and positioned adjacent laterally opposed heating elements 23 or similar other means for caramelizing the marshmallow 10 is believed superior to simply statically positioning a marshmallow adjacent a heat source. The action of rotation provides periodic and controllable exposure to direct radiant heat 105 while positioned within a heated ambient environment. This process operates to more uniformly heat the outer skin of the marshmallow for effecting superior caramelization.

Key factors for effecting the Maillard reaction, by contrast, include high temperature, low moisture levels, and an alkaline environment. A traditional toaster involves the static placement of bread within a toasting chamber or slot and thereby provides constant exposure to direct radiant heat within a heated ambient environment for effecting optimum conditions for the Maillard reaction at the surface of the bread.

In other words, uniformity of heat is central to effective caramelization and quantity of heat is central to achieve an effective Maillard reaction. In the current application, the rotatable skewer member 20 is positioned adjacent certain means for caramelizing the outer skin of a spit-skewered marshmallow, and is thus to be preferred over static or non-rotational placement of a marshmallow adjacent a heat source.

It is further contemplated, however, that the means for caramelizing the outer skin of the marshmallow 10 may be exemplified by an open flame 107, as may be directed upwardly into the cavity or chamber 16 via the bottom portion 19, which bottom portion 19 may be outfitted with certain conduit 50 for directing fuel. In other words, the conduit 50 may direct fuel for providing a source of open flame 107 for heating the marshmallow(s) 10. A spark generator 51 or similar other means for igniting the fuel may be further included within, or otherwise cooperable with the housing 12. A diagrammatic fuel source 52 is further depicted in FIGS. 4 and 8, which source 52 may be coupled or otherwise connected with the conduit 50.

A forth embodiment of the marshmallow toasting apparatus 94 according to the present invention is generally depicted in FIG. 12. The marshmallow toasting apparatus 94 functions to caramelize the outer skin of marshmallow, but does so be elevating skewered marshmallows in superior adjacency to a centralized heated chamber 97 (akin to cavity-receiving chamber 17) as defined by a peripheral wall 98 (akin to walls 14, 15, and 18). Notably, peripheral wall 98 comprises no common slot 16 or similar type structure. Rather, opposed portions of the wall 98 comprise certain means for elevating a skewer member 20 in superior adjacency to the chamber 97.

It is contemplated that the skewer-elevating means may be preferably defined by certain skewer-elevating tabs 95 or posts, which tabs extend upwardly from the opposed portions of the wall 98. The tabs may be slotted as at 96 and thus may readily accept the skewer member 20 and enable rotation motion substantially as previously described. The heat energy imparted into the chamber 97 (substantially as previously described) thus provides a substantially uniform heat source inferior to skewered marshmallows 10. It is thus contemplated that both radiant heat and convectional heat may well function to more uniformly heat and caramelize the outer skin of the skewered marshmallows.

While the above description contains much specificity, this specificity should not be construed as limitations on the scope of the invention, but rather as an exemplification of the invention. For example, as is described hereinabove, it is contemplated that the present invention essentially discloses a marshmallow toasting apparatus for caramelizing the outer skin of marshmallow, which apparatus may essentially comprise a housing, a rotisserie assembly, and certain heat sourcing means.

The geometry of the housing is specifically designed to receive and position a skewered marshmallow within a marshmallow-receiving cavity or marshmallow expansion chamber. The housing thus includes a top wall and a front wall with a common slot extending therebetween. The common slot, in part, defines the marshmallow-receiving cavity or marshmallow expansion chamber and further defines a skewer-receiving or spit-receiving plane.

The rotisserie assembly 22 may be said to essentially comprise a marshmallow-skewering member 20 and certain automatic means for rotating the skewer member 20 about its axis, as may be exemplified by an electric motor assembly. A motor housing is depicted at 28 in FIG. 7(a).

It is contemplated that the rotisseries assembly may be pivoted intermediate a marshmallow loading configuration as shown in solid lines in the noted figure, and a marshmallow toasting configuration as at 111. The skewer member 20 is receivable in the spit-receiving plane and rotatable therein, preferably being substantially parallel to the top wall 13. The heat sourcing means essentially functions to caramelize the outer skin of skewered marshmallow, and is thus mounted within the housing adjacent the cavity or chamber 17 for sourcing heat 106 to the chamber or cavity 17.

The marshmallow expansion chamber 17 may be defined by the front, back and side walls of the housing and is sized and shaped for enabling structurally free thermal expansion of one or more marshmallow(s) during application of heat 106 to the cavity 17. In this regard, it is contemplated that the cavity has a lateral cavity width, which cavity width is greater in magnitude than the width of the common slot or common slot width for accommodating marshmallow expansion during application of heat 106.

The common slots 16 at the front and back walls may preferably comprise certain means for rotatably supporting the skewer member during rotation about its axis. In other words, the skewer member may be rested upon the slot terminus as at 25 formed in one or both of the front and back walls 14 and 15. Certain means for automatically timing the heat sourcing means may be included for applying heat to the cavity for select time periods.

Said means may be defined by common state of the art timers and timing means, as may be exemplified by a thermostatic switch or similar other mechanism. Further, the cavity or chamber 17 may comprise certain means for reflecting heat energy therewithin for enhancing heat uniformity within the cavity. In this regard, it is contemplated that the chamber walls may be outfitted with energy reflective material or structure, such as polished metallic materials or mirror-like structure.

The foregoing specifications are further thought to support certain methodology for caramelizing or toasting the outer skin of a marshmallow 10, and in this regard the series of steps may be said to include skewering a marshmallow with a skewer member or spit; slot-receiving the spit-skewered marshmallow, which step functions to centrally position the marshmallow 10 relative to peripheral marshmallow expansion chamber walls.

When so positioned heat energy 106 may be directed toward the marshmallow from a select marshmallow expansion chamber wall (as may be selected from the group consisting of side walls, for example). The application of heat 106 operates to (1) thermally expand the marshmallow toward or in the direction of the marshmallow expansion chamber walls, and (2) caramelize the outer skin of the expanding marshmallow 80 via the directed heat energy 106 (inclusive of energy 105).

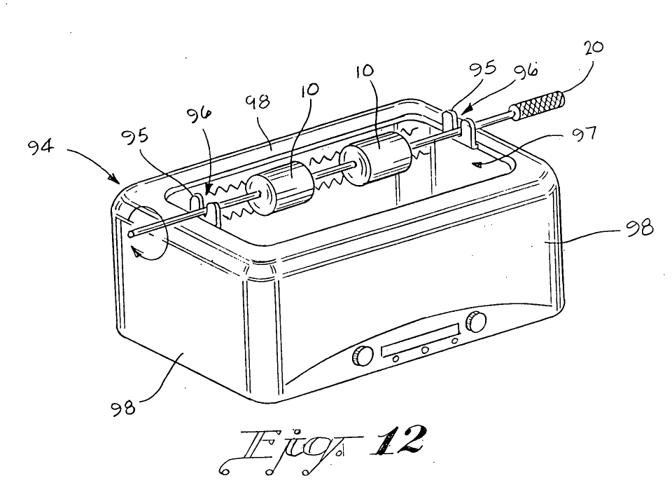

The marshmallow may preferably be rotated after being slot-received. In this regard, it is contemplated that marshmallow rotation may be constant or have a constant rotational speed, thereby periodically exposing the marshmallow 10 to direct heat energy from the select chamber wall. In this regard, the reader is directed to FIGS. 9 and 10, which generally and comparatively depict opposing points 60 and 61 on the outer skin of the marshmallow 10. When rotated as at 112, the opposing points 60 and 61 naturally trace out a circular path. Given a constant rotational speed, each point 60 and 61 will pass through 2π radians within the same, and repeated, time intervals for enhancing the caramelization process.

The speed of skewer member rotation, although preferably constant, is not critical and likely can not be assumed if rotation of the skewer member 20 is performed manually. What is critical is that the speed not be zero, too slow, or too rapid. During testing, a speed of rotation ranging from 6-10 rotations per minute with an average target of 8 rotations per minute yielded optimum results based upon state of the art bread-toaster type heating elements. It is contemplated that different optimum rotations per minute may be more properly established based on the manufacturer's preferred heat exposure time, watts (BTU's), distance to the elements (flame), etc.

As earlier stated, the step of slot-receiving the spit-skewered marshmallow 10 may itself operate to close a heat supply timing circuit, thereby directing heat energy 106 from the select chamber wall toward the marshmallow until the timing circuit opens, which timing sequence or period may be preset by the user via the controls. Finally, the methodology may include the step of reflecting heat energy 106 from the marshmallow expansion chamber walls toward the marshmallow for enhancing the uniformity of heat energy within the chamber and more thoroughly and effectively caramelize the outer skin of the marshmallow. Note, for example, that heat energy may be directed toward the circular ends 62 of the marshmallow 10 for toasting the same.

Although the invention has been described by reference to several preferred embodiments and certain methodology, it is not intended that the construction of the toasting apparatus and method be limited thereby, but that modifications thereof are intended to be included as falling within the broad scope and spirit of the foregoing disclosure and the appended drawings.

I claim:

1. A marshmallow toasting apparatus for caramelizing the outer skin of marshmallow, said apparatus comprising:
a housing, the housing including a top wall and a front wall, the top and front walls having a common slot extending therebetween, the common slot defining a marshmallow-receiving cavity and a member-receiving plane;
a rotisserie assembly, the rotisserie assembly comprising a marshmallow-skewering member and means for rotating the member about its axis, the member being receivable in the member-receiving plane and being rotatable therein substantially parallel to the top wall; and
heat sourcing means for caramelizing the outer skin of marshmallow, said means being mounted within the housing adjacent the cavity for sourcing heat to the cavity.

2. The marshmallow toasting apparatus of claim 1 wherein the cavity is sized and shaped for enabling structurally free thermal expansion of marshmallow during application of heat to the cavity.

3. The marshmallow toasting apparatus of claim 2 wherein the cavity has a lateral cavity width and the common slot at the front wall has a lateral slot width, the cavity width being greater in magnitude than the slot width for accommodating marshmallow expansion during application of heat to the cavity.

4. The marshmallow toasting apparatus of claim 1 wherein the housing comprises a back wall, the common slot extending intermediate the top, front and back walls.

5. The marshmallow toasting apparatus of claim 4 wherein the common slot at the front and back walls comprises means for rotatably supporting the member during rotation about its axis.

6. The marshmallow toasting apparatus of claim 1 comprising timing means for automatically timing the heat sourcing means, said timing means operating to automatically apply heat to the cavity for select time periods.

7. The marshmallow toasting apparatus of claim 1 wherein the cavity comprises means for reflecting heat energy therewithin, said means for enhancing heat uniformity within the cavity.

8. A marshmallow toasting apparatus for caramelizing the outer skin of marshmallow, said apparatus comprising:
a housing, the housing including a top wall and a front wall, the top and front walls having a common slot extending therebetween, the common slot defining a marshmallow-receiving cavity and a member-receiving plane;
a skewer member, the member being receivable in the member-receiving plane and being rotatable therein; and
heat sourcing means for caramelizing the outer skin of marshmallow, said means being mounted within the housing adjacent the cavity for sourcing heat to the cavity.

9. The marshmallow toasting apparatus of claim 8 comprising automatic means for rotating the member about its axis.

10. The marshmallow toasting apparatus of claim 8 wherein the cavity is sized and shaped for enabling structurally free thermal expansion of marshmallow during application of heat to the cavity.

11. The marshmallow toasting apparatus of claim 8 wherein the cavity has a lateral cavity width and the common slot at the front wall has a lateral slot width, the cavity width being greater in magnitude than the slot width for accommodating marshmallow expansion during application of heat to the cavity.

12. The marshmallow toasting apparatus of claim 8 wherein the common slot at the front and wall comprises means for rotatably supporting the spit during rotation about its axis.

13. The marshmallow toasting apparatus of claim 8 wherein the housing comprises a back wall, the common slot extending intermediate the top, front and back walls.

14. The marshmallow toasting apparatus of claim 8 comprising timing means for automatically timing the heat sourcing means, said timing means operating to automatically apply heat to the cavity for select time periods.

15. The marshmallow toasting apparatus of claim 8 wherein the cavity comprises means for reflecting heat energy therewithin, said means for enhancing heat uniformity within the cavity.

16. A marshmallow toasting apparatus for caramelizing the outer skin of marshmallow, said apparatus comprising:
a housing, the housing having a peripheral wall defining a centralized heat chamber, opposed portions of said wall comprising skewer-elevating means for elevating a skewer member in superior adjacency to the heat chamber;
a skewer member, the skewer member being cooperable with said skewer elevating means for elevating a skewered marshmallow in superior adjacency to the heat chamber; and
heat sourcing means for caramelizing the outer skin of marshmallow, said means being mounted within the housing adjacent the heat chamber for sourcing heat to the heat chamber.

17. A marshmallow toasting method for caramelizing the outer skin of marshmallow, said method comprising the steps of:
skewering a marshmallow with a spit;
slot-receiving the spit-skewered marshmallow, thereby positioning the marshmallow within peripheral marshmallow expansion chamber walls;
directing heat energy toward the marshmallow from a select marshmallow expansion chamber wall;
thermally expanding the marshmallow toward the peripheral marshmallow expansion chamber walls; and
caramelizing an outer skin of the marshmallow via the directed heat energy.

18. The marshmallow toasting method of claim 17 comprising the step of rotating the marshmallow after slot-receiving the spit-skewered marshmallow.

19. The marshmallow toasting method of claim 18 wherein the marshmallow rotation is at a constant rotational speed, thereby periodically exposing the marshmallow to direct heat energy from the select chamber wall.

20. The marshmallow toasting method of claim 17 wherein the step of slot-receiving the spit-skewered marshmallow closes a heat supply timing circuit, heat energy being directed from the select chamber wall until the timing circuit opens.

21. The marshmallow toasting method of claim 17 comprising the step of reflecting heat energy from the marshmallow expansion chamber walls toward the marshmallow.

22. A marshmallow toasting method for caramelizing the outer skin of marshmallow, said method comprising the steps of:
skewering a marshmallow with a marshmallow rotisserie;
slot-receiving the rotisserie-skewered marshmallow, thereby positioning the marshmallow within peripheral marshmallow expansion chamber walls;
simultaneously directing heat energy toward the marshmallow from a select marshmallow expansion chamber wall and rotating the marshmallow via the marshmallow rotisserie;
thermally expanding the marshmallow toward the peripheral marshmallow expansion chamber walls; and
caramelizing an outer skin of the marshmallow via the directed heat energy.

23. The marshmallow toasting method of claim 22 wherein the marshmallow rotation is at a constant rotational speed, thereby periodically exposing the marshmallow to direct heat energy from the select chamber wall.

24. The marshmallow toasting method of claim 22 wherein the step of slot-receiving the spit-skewered marshmallow closes a heat supply timing circuit, heat energy being directed from the select chamber wall until the timing circuit opens.

25. The marshmallow toasting method of claim 22 comprising the step of reflecting heat energy from the marshmallow expansion chamber walls toward the marshmallow.
